(19) United States
(12) Patent Application Publication
(10) Pub. No.: US 2011/0196537 A1
(43) Pub. Date: Aug. 11, 2011

(54) DISTRIBUTION CONTROL METHOD EQUIPPED WITH CHEMICAL VALVE BOXES

(76) Inventor: Tso-Sung HUNG, Zhubei City (TW)

(21) Appl. No.: 12/703,769

(22) Filed: Feb. 11, 2010

(51) Int. Cl. G05B 15/02; G05D 7/06

(52) U.S. Cl. 700/266; 700/282

(57) ABSTRACT

A distribution control method equipped with chemical valve boxes comprises providing a microcomputer parameter control system, at least one intelligent chemical valve box distribution system and a plurality of chemical supply systems. The microcomputer parameter control system is linked to the intelligent chemical valve box distribution system and the chemical supply systems via a wireless or wired connection means. The intelligent chemical valve box distribution system is linked to the chemical supply systems. The chemical supply systems supply medicinal liquids to a targeted machine through a chemical piping, a branch box and a chemical valve box. The microcomputer parameter control system sets related control parameters and uploads the control parameters to the intelligent chemical valve box distribution system or downloads the control parameters of the intelligent chemical valve box distribution system and performs editing, thus can save the control cost of the chemical supply systems.

### FIELD OF THE INVENTION

The present invention relates to a chemical control system and particularly to a control method for chemical control systems.

### BACKGROUND OF THE INVENTION

Please refer to FIG. 1, in a chemical plant, semiconductor plant or petrochemical plant, at least one chemical supply system 1 is needed to provide various types of medicinal liquids in various fabrication processes to meet production requirements.

The chemical supply system 1 is linked to a microcomputer parameter control system 7 and supplies the medicinal liquids to a targeted machine 3 through a chemical piping 8, a branch box 6 and a chemical valve box 2. The chemical valve box 2 is controlled through a solenoid valve box 5 to determine whether the medicinal liquids have to be added. Each chemical supply system 1 requires its own parameter controller 4. In the event that production process is changed and the dosage of the added medicinal liquids has to be altered, the parameter controller 4 has to be changed or replaced individually.

### SUMMARY OF THE INVENTION

The primary object of the present invention is to provide a distribution control method equipped with chemical valve boxes that can instantly upload or download parameters for editing. In the event that the dosage or type of medicinal liquids has to be changed, the present invention can meet the requirement immediately.

To achieve the foregoing object, the distribution control method provided by the present invention comprises the procedures as follow:

Provide a microcomputer parameter control system, at least one intelligent chemical valve box distribution system and a plurality of chemical supply systems. The microcomputer parameter control system is linked to the intelligent chemical valve box distribution system and the chemical supply systems. The intelligent chemical valve box distribution system is linked to the chemical supply systems. The chemical supply systems supply medicinal liquids to a targeted machine through a chemical piping, a branch box and a chemical valve box. The microcomputer parameter control system sets control parameters of the intelligent chemical valve box distribution system to control operations of the chemical supply systems and the chemical valve box, and store the control parameters of the intelligent chemical valve box distribution system, and also selectively upload the control parameters to the intelligent chemical valve box distribution system or download the control parameters to return to the previous step to allow the microcomputer parameter control system to reset and edit the control parameters.

By linking and controlling the chemical supply systems through the intelligent chemical valve box distribution system of the present invention, control cost of the chemical supply systems can be saved. In the event that the dosage or type of the medicinal liquids required by the targeted machine is altered, the present invention can directly upload or download the control parameters and modify the control parameters.

The foregoing, as well as additional objects, features and advantages of the invention will be more readily apparent from the following detailed description, which proceeds with reference to the embodiment and accompanying drawings. The embodiment serves merely for illustrative purpose and is not the limitation of the invention.

### BRIEF DESCRIPTION OF THE DRAWINGS

FIG. 1 is a schematic view of a conventional system.

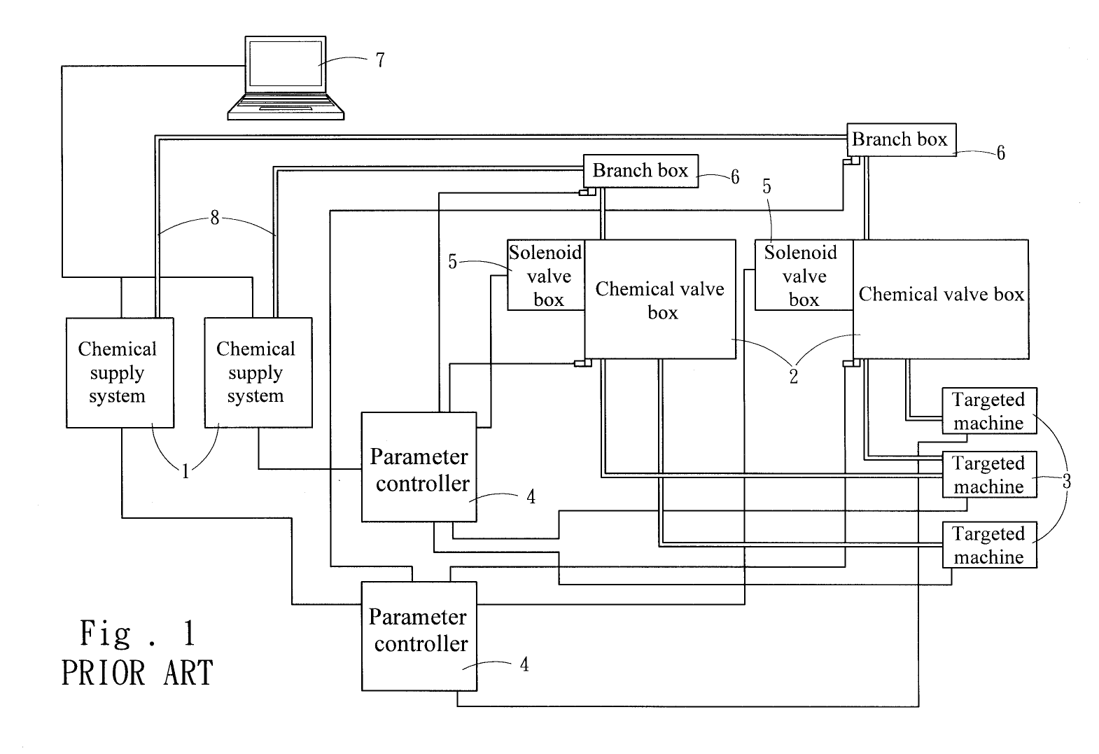

FIG. 2 is a schematic view of the present invention.

FIG. 3 is an operation flowchart of the present invention.

### DETAILED DESCRIPTION OF THE PREFERRED EMBODIMENT

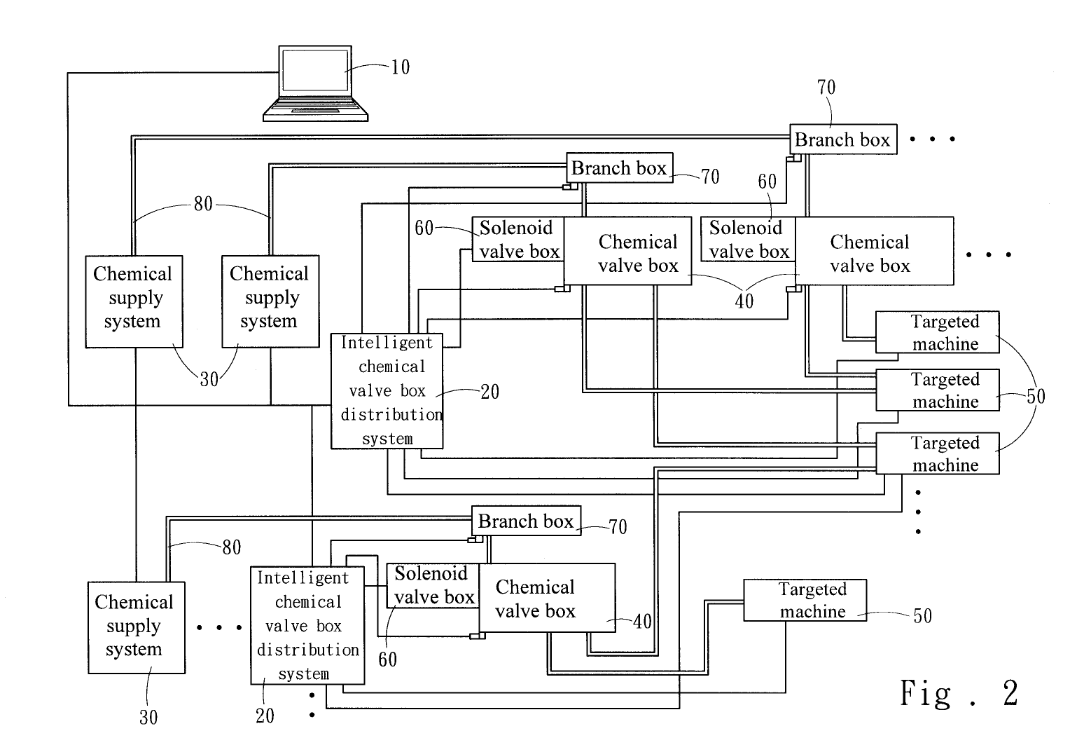

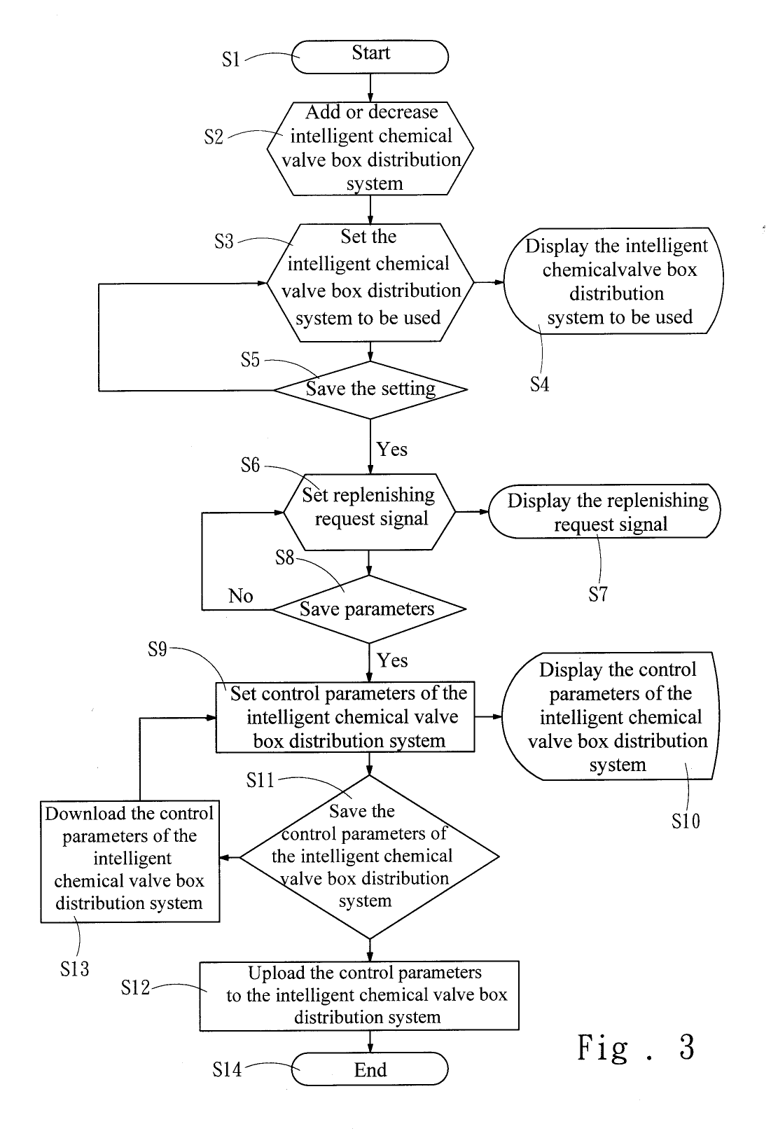

Please refer to FIGS. 2 and 3, the distribution control method equipped with chemical valve boxes according to the present invention comprises procedures of step S1 through S14 as elaborated below:

First, provide a microcomputer parameter control system 10, at least one intelligent chemical valve box distribution system 20 and a plurality of chemical supply systems 30. The microcomputer parameter control system 10 is connected to the intelligent chemical valve box distribution system 20 and the chemical supply systems 30 through a wireless or wired connection. The intelligent chemical valve box distribution system 20 also is linked to the chemical supply systems 30. The chemical supply systems 30 supply medicinal liquids to a targeted machine 50 through a chemical piping 80, a branch box 70 and a chemical valve box 40.

The chemical valve box 40 is controlled through a solenoid valve box 60 to determine whether the medicinal liquids are added. The intelligent chemical valve box distribution system 20 can receive a replenishing request signal from the targeted machine 50 and sends the replenishing request signal to the chemical supply systems 30. After the chemical supply systems 30 have confirmed that the request can be met, the medicinal liquids are supplied. Meanwhile, a solenoid valve signal is sent to the solenoid valve box 60 to activate the chemical valve box 40 to allow the medicinal liquids to pass through the branch box 70 and the chemical valve box 40 to the targeted machine 50, and also monitor leakage signals of the branch box 70 and chemical valve box 40. In the event that liquid leakage is detected, supply of the medicinal liquids is suspended.

In the event that the chemical supply systems 30 cannot supply the medicinal liquids, the chemical supply systems 30 feedback an alert message to the microcomputer parameter control system 10 to be displayed thereon. A physical signal also is sent by the intelligent chemical valve box distribution system 20 to the targeted machine 50.

Next, set the replenishing request signal on the targeted machine 50. Before setting the replenishing request signal, steps S2-S5 are preceded. Referring to steps S2-S5, step S2 aims to add or decrease the intelligent chemical valve box distribution system 20 to be used; step S3 aims to set the intelligent chemical valve box distribution system 20 to be used through the microcomputer parameter control system 10; step S4 aims to display the intelligent chemical valve box distribution system 20 to be used for conformation; step S5 aims to save the setting.

Thus according to steps S2 through S5, the number of the intelligent chemical valve box distribution system 20 can be selected, added or decreased as required. When the number of the intelligent chemical valve box distribution system 20 can be linked to the chemical supply systems 30 is restricted or the number of the replenishing request signal of the targeted machine 50 is limited, the number of the intelligent chemical valve box distribution system 20 can be selected or added according to actual requirements.

Setting the replenishing request signal includes steps S6 through S8. At step S6, the microcomputer parameter control system 10 sets the replenishing request signal and determines which of the chemical supply systems 30 to be used; step S7 aims to display the set replenishing request signal for confirmation; step S8 aims to save the parameters. Through the replenishing request signal, the chemical supply systems 30 to be used can be recorded. Hence when the intelligent chemical valve box distribution system 20 is linked to multiple chemical supply systems 30, which one or more chemical supply systems 30 to be used can be known through the replenishing request signal.

Next, steps S9-S10 are executed. At step S9, the microcomputer parameter control system 10 sets the control parameters of the intelligent chemical valve box distribution system 20 to control operations of the chemical supply systems 30 and chemical valve box 40, and also set status signals of liquid leakage monitoring of the branch box 70 and chemical valve box 40 and the chemical supply systems 30. At step S10, after the control parameters of the intelligent chemical valve box distribution system 20 are set, the control parameters of the intelligent chemical valve box distribution system 20 are displayed for confirmation.

Finally, steps S11, S12 and S13 are executed. Step S11 aims to save the control parameters of the intelligent chemical valve box distribution system 20. Step S12 aims to upload the control parameters of the intelligent chemical valve box distribution system 20 to the intelligent chemical valve box distribution system 20. Step S13 aims to download the control parameters of the intelligent chemical valve box distribution system 20 and return to the previous step to allow the microcomputer parameter control system 10 to reset and edit the control parameters of the intelligent chemical valve box distribution system 20, and save the set control parameters and upload to the intelligent chemical valve box distribution system 20, or download the control parameters through the intelligent chemical valve box distribution system 20 to be edited and uploaded then.

By means of the steps set forth above, when the dosage or types of the medicinal liquids required by the targeted machine 50 is changed, through the microcomputer parameter control system 10 of the present invention, the parameters can be directly modified and uploaded to the intelligent chemical valve box distribution system 20 to instantly meet requirements. Moreover, the present invention allows at least one intelligent chemical valve box distribution system 20 to link multiple chemical supply systems 30 correspondingly. Hence the chemical supply systems 30 do not need to use individual parameter controllers, but share at least one intelligent chemical valve box distribution system 20. Thus the present invention can save the cost of driving and controlling of the chemical supply systems 30 and meet user's requirements.

What is claimed is:

1. A distribution control method equipped with chemical valve boxes, comprising the steps of:
providing a microcomputer parameter control system, at least one intelligent chemical valve box distribution system and a plurality of chemical supply systems; the microcomputer parameter control system being linked to the intelligent chemical valve box distribution system and the chemical supply systems, the intelligent chemical valve box distribution system being linked to the chemical supply systems, the chemical supply systems supplying medicinal liquids to a targeted machine through a chemical piping, a branch box and a chemical valve box;
setting control parameters of the intelligent chemical valve box distribution system through the microcomputer parameter control system to control operations of the chemical supply systems and the chemical valve box; and
storing the control parameters of the intelligent chemical valve box distribution system and selectively uploading the control parameters to the intelligent chemical valve box distribution system or downloading the control parameters and returning to the previous step to allow the microcomputer parameter control system to re set and edit the control parameters.

2. The distribution control method of claim 1 further including a step of setting a replenishing request signal on the targeted machine and determining which of the chemical supply systems to be used.

3. The distribution control method of claim 2, wherein the chemical valve box is controlled by a solenoid valve box to determine whether the medicinal liquids to be added; the intelligent chemical valve box distribution system receiving the replenishing request signal of the targeted machine to know whether the medicinal liquids are needed and sending the replenishing request signal to the chemical supply systems to confirm whether the medicinal liquids can be supplied, and sending a solenoid valve signal to the solenoid valve box when the chemical supply systems supplying the medicinal liquids to activate the chemical valve box to allow the medicinal liquids to enter the targeted machine, and monitoring liquid leakage signals of the branch box and the chemical valve box, and stopping supplying the medicinal liquids when liquid leakage is detected.

4. The distribution control method of claim 2, wherein when the replenishing request signal is sent by the intelligent chemical valve box distribution system to the chemical supply systems and the chemical supply systems cannot supply the medicinal liquids, the chemical supply systems feedback an alert message displayed on the microcomputer parameter control system and the intelligent chemical valve box distribution system.

5. The distribution control method of claim 2, wherein a step of setting the replenishing request signal is preceded by adding or decreasing the intelligent chemical valve box distribution system to be used through the microcomputer parameter control system.
